(19) United States
(12) Patent Application Publication
(10) Pub. No.: US 2010/0127424 A1
(43) Pub. Date: May 27, 2010

(54) Fabrication of metal meshes/carbon nanotubes/polymer composite bipolar plates for fuel cell

(75) Inventors: Chen-Chi Martin Ma, Hsinchu (TW); Min-Chien Hsiao, Hsinchu (TW); Shu-Hang Liao, Hsinchu (TW); Ming-Yu Yen, Hsinchu (TW); Chaun-Yu Yen, Hsinchu (TW); Jeng-Chin Weng, Hsinchu (TW); Shuo-Jen Lee, Taipei (TW)

Correspondence Address: BACON & THOMAS, PLLC, 625 SLATERS LANE, FOURTH FLOOR, ALEXANDRIA, VA, 22314-1176, US

(73) Assignee: YUAN ZE UNIVERSITY, Taoyuan (TW)

(21) Appl. No.: 12/457,353

(22) Filed: Jun. 9, 2009

(30) Foreign Application Priority Data
Nov. 27, 2008 (TW) 97146052

(51) Int. Cl. B29C 51/42

(52) U.S. Cl. 264/279.1; 264/331.18; 977/742; 977/750; 977/752

(57) ABSTRACT

A reinforced mesh structure containing bipolar plate for a polymer electrolyte membrane fuel cell (PEMFC) is prepared as follows: a) compounding vinyl ester and graphite powder to form bulk molding compound (BMC) material, the graphite powder content ranging from 60 wt % to 95 wt % based on the total weight of the graphite powder and vinyl ester, wherein 0.05-10 wt % reactive carbon nanotubes modified by acyl chlorination-amidization reaction, based on the weight of the vinyl ester resin, are added during the compounding; b) molding the BMC material from step a) with a metallic net being embedded in the molded BMC material to form a bipolar plates having a desired shaped at 80-200° C. and 500-4000 psi.

### FIELD OF THE INVENTION

The present invention relates to a method for preparing a fuel cell composite bipolar plate, and particularly to a method for preparing a fuel cell bipolar plate by a bulk molding compound (BMC) process with reactive carbon nanotubes modified by acyl chlorination-amidization reaction and with a metallic net being embedded in the molded BMC material.

### BACKGROUND OF THE INVENTION

USP 2005/0025694 A1 has discloses a method for stably dispersing carbon nanotubes (CNTs) in an aqueous solution or oil, wherein the CNTs can be multi-walled or single-walled. According to the invention, there is no need of modifying the surface of CNTs into hydrophilic nature. The disclosed method only requires adding a selective dispersion agent and then the resulting mixture is mixed and dispersed using ultrasonic oscillation or a high shear homogenizer rotating at a high speed for achieving the objective of uniformly dispersing CNTs in the aqueous solution. A dispersion agent with an HLB value less than 8 is chosen if the CNTs are to be dispersed in oil; a dispersion agent with an HLB value greater than 10 is chosen if the CNTs are to be dispersed in the water phase.

According to CN 1667040 A1, the surfaces of CNTs are modified by at least a coupling agent selected from the group consisting of a silane coupling agent and a titanate coupling agent in an organic solvent which is selected from the group consisting of xylene, n-butanol, and cyclohexanone. After thorough mixing, the mixture is added with at least a dispersion agent selected from the group consisting of polypriopionate and modified polyurethane. After receiving an ultrasonic treatment, the mixture is uniformly dispersed in an epoxy resin by using a high speed agitation disperser. According to this modification/dispersion method, CNTs are dispersed easily, uniformly, and stably. The resulting CNT/polymer composites are a good antistatic material with good corrosion resistance, heat resistance, solvent resistance, high strength, and high adhesion.

USP 2004/0136894 A1 provides a method for dispersing CNTs in liquid or polymer, which comprises modifying the surfaces of CNTs by adding nitric acid to CNTs and refluxing the resulting mixture in 120° C. oil bath for 4 hours, so that functional groups are grafted onto the defective sites on the surfaces of the CNTs; adding a polar volatile solvent as medium to disperse the modified CNTs therein by stirring with a stirrer or ultrasonication with help from a polar force from the solvent which is able to dissolve a polymer or resin to be added; and adding the polymer or resin to the resulting dispersion, and evaporating the solvent to obtain uniform dispersion of the CNTs in the polymer or resin.

USP 2006/0058443 A1 discloses a composite material with reinforced mechanical strength by using CNTs. According to the invention, CNTs receive ultraviolet irradiation first, followed by a plasma treatment or treated with an oxidization agent, e.g. sulfuric acid or nitric acid, in order to obtain CNTs with hydrophilic groups. Subsequently, a surfactant is used to disperse the hydrophilic CNTs in a polymeric resin in order to obtain a composite material with reinforced mechanical strength by CNTs.

USP 2006/0052509 A1 discloses a method of preparing a CNT composite without adversely affecting the properties of CNTs per se. According to the invention, the surfaces of CNTs are grafted with a conductive polymer or heterocyclic trimer, which is soluble in water and contain sat least a sulfuric group and carboxylic group. The resulting CNTs are dispersed or dissolved in water, organic solvent, or organic aqueous solution after receiving ultrasonic oscillation. Even after long term storage, such a dispersion or solution will not develop agglomeration. Furthermore, such a composite material has good conductivity and film formation properties, and is easy to be coated or used as a substrate.

U.S. Pat. No. 7,090,793 discloses a composite bipolar plate of polymer electrolyte membrane fuel cells (PEMFC), which is prepared as follows: a) preparing a bulk molding compound (BMC) material containing a vinyl ester resin and a graphite powder, the graphite powder content of BMC material ranging from 60 wt % to 80 wt %, based on the compounded mixture; b) molding the BMC material from step a) to form a bipolar plate having a desired shape at 80-200° C. and 500-4000 psi, wherein the graphite powder is of 10 mesh-80 mesh. Details of the disclosure in this US patent are incorporated herein by reference.

Taiwan patent publication No. 200624604, published 16 Jul. 2006, discloses a PEMFC, which is prepared as follows: a) compounding phenolic resin and carbon fillers to form bulk molding compound (BMC) material, the BMC material containing 60 to 80 wt % graphite powder, 1 to 10 wt % carbon fiber; and one ore more conductive carbon fillers selected from: 5 to 30 wt % Ni-planted graphite powder, 2 to 8 wt % Ni-planted carbon fiber and 0.01 to 0.3 wt % carbon nanotubes, based on the weight of the phenolic resin, provided that the sum of the amounts of the carbon fiber and Ni-planted carbon fiber is not greater than 10 wt %; b) molding the BMC material from step a) to form a bipolar plates having a desired shape at 80-200° C. and 500-4000 psi. The carbon nanotubes used in this prior art are single-walled or double-walled carbon nanotubes having a diameter of 0.7-50 nm, length of 1-1000 μm, specific surface area of 40-1000 m²/g. Details of the disclosure in this Taiwan patent publication are incorporated herein by reference.

USP 2006/0267235 A1 discloses a composite bipolar plate for a PEMFC, which is prepared as follows: a) compounding vinyl ester and graphite powder to form bulk molding compound (BMC) material, the graphite powder content ranging from 60 wt % to 95 wt % based on the total weight of the graphite powder and vinyl ester, wherein carbon fiber 1-20 wt %, modified organo clay or noble metal plated modified organo clay 0.5-10 wt %, and one or more conductive fillers selected form: carbon nanotube (CNT) 0.1-5 wt %, nickel plated carbon fiber 0.5-10 wt %, nickel plated graphite 2.5-40 wt %, and carbon black 2-30 wt %, based on the weight of the vinyl ester resin, are added during the compounding; b) molding the BMC material from step a) to form a bipolar plate having a desired shaped at 80-200 ° C. and 500-4000 psi. Details of the disclosure in this US patent publication are incorporated herein by reference.

USP 2007/0241475 A1 discloses a composite bipolar plate for a PEMFC, which is prepared as follows: a) compounding vinyl ester and graphite powder to form bulk molding compound (BMC) material, the graphite powder content ranging from 60 wt % to 95 wt % based on the total weight of the graphite powder and vinyl ester, wherein 0.5-10 wt % modified organo clay by intercalating with a polyether amine, based on the weight of the vinyl ester resin, is added during the compounding; b) molding the BMC material from step a) to form a bipolar plates having a desired shaped at 80-200° C. and 500-4000 psi. Details of the disclosure in this US patent publication are incorporated herein by reference.

U.S. patent application Ser. No. 11/812,405, filed 19 Jun. 2007, commonly assigned to the assignee of the present application discloses TiO₂-coated CNTs formed by a sol-gel method or hydrothermal method. Furthermore, the TiO₂-coated CNTs are modified with a coupling agent to endow the TiO₂-coated CNTs with affinity to polymer substrates. The modified TiO₂-coated CNTs can be used as an additive in polymers or ceramic materials for increase the mechanical strength of the resulting composite materials. The CNT/polymer composite material prepared according to this prior art can be used to impregnate fiber cloth to form a prepreg material. Details of the disclosure in this US patent application are incorporated herein by reference.

To this date, the industry is still continuously looking for a smaller fuel cell bipolar plate having a high electric conductivity, excellent mechanical properties, a high thermal stability and a high size stability.

### SUMMARY OF THE INVENTION

One primary objective of the present invention is to provide a small size fuel cell bipolar plate having a high electrical conductivity, high thermal conductivity and excellent mechanical properties, and preparation method thereof.

Another objective of the present invention is to provide reactive carbon nanotubes modified by acyl chlorination-amidization reaction and preparation method thereof.

Another primary objective of the present invention is to provide a carbon nanotubes reinforced polymer composite bipolar plate for fuel cell with reactive carbon nanotubes modified by acyl chlorination-amidization reaction, and preparation method thereof.

The present invention discloses a process for preparing a composite bipolar plate for a PEMFC by a BMC process with a BMC material comprising vinyl ester, a conductive carbon, and reactive carbon nanotubes modified by acyl chlorination-amidization reaction, wherein the reactive carbon nanotubes modified by acyl chlorination-amidization reaction are well dispersed in the resin system, so that a vinyl ester/graphite composite bipolar plate having a high electrical conductivity, high thermal conductivity and excellent mechanical properties is prepared.

Further, a metallic net such as stainless steel net can be embedded in the composite to enhance electrical conductivity, thermal conductivity and mechanical properties of the bipolar plate of the present invention.

In one of the preferred embodiments of the present invention said reactive carbon nanotubes modified by acyl chlorination-amidization reaction was prepared by reacting acidified carbon nanotubes with thionyl chloride (SOCl₂) to obtain acyl-chlorination carbon nanotubes; and conducting an amidization reaction between said acyl-chlorination carbon nanotubes and an oligomer resulting from a ring-opening reaction between a polyether amine and maleic anhydride to obtain reactive carbon nanotubes modified by acyl chlorination-amidization reaction. The reactive carbon nanotubes modified by acyl chlorination-amidization reaction are able to be dispersed in the resin system and are reactive, so that a vinyl ester/graphite composite bipolar plate having a high electrical conductivity, high thermal conductivity and excellent mechanical properties was prepared, which has a volume conductivity greater than 640 S/cm, a thermal conductivity of 10 W/mk, and a flexural strength as high as about 39 MPa. The volume conductivity greater than 640 S/cm is significantly higher than the technical criteria index of 100 S/cm of DOE of US.

In another preferred embodiments of the present invention a metallic net was introduced during the bulk molding compound process to prepare a vinyl ester/graphite composite bipolar plate having a high electrical conductivity, high thermal conductivity and excellent mechanical properties was prepared, which has a volume conductivity greater than 640 S/cm, a thermal conductivity of 21 W/mk, and a flexural strength as high as about 44 MPa.

In order to accomplish the aforesaid objectives a process for preparing a composite bipolar plate for a polymer electrolyte membrane fuel cell (PEMFC) according to the present invention comprises:

a) compounding vinyl ester and graphite powder to form bulk molding compound (BMC) material, the graphite powder content ranging from 60 wt % to 95 wt % based on the total weight of the graphite powder and vinyl ester, wherein 0.05-10 wt % reactive carbon nanotubes modified by acyl chlorination-amidization reaction, based on the weight of the vinyl ester resin, are added during the compounding;

b) molding the BMC material from step a) to form a bipolar plate having a desired shaped at 80-200° C. and 500-4000 psi.

A suitable process for preparing said reactive carbon nanotubes modified by acyl chlorination-amidization reaction comprises the following steps: 1) reacting carbon nanotubes with a strong acid under refluxing to form acidified carbon nanotubes; 2) reacting the acidified carbon nanotubes from step 1) with thionyl chloride (SOCl₂) to obtain acyl-chlorination carbon nanotubes having —COCl bounded to surfaces thereof; 3) conducting an amidization reaction between said acyl-chlorination carbon nanotubes and a polyamic acid resulting from a ring-opening reaction between a polyether amine and a dicarboxylic acid anhydride containing an ethylenically unsaturated group to obtain reactive carbon nanotubes modified by acyl chlorination-amidization reaction.

Preferably, said dicarboxylic acid anhydride containing an ethylenically unsaturated group is maleic anhydride.

Preferably, the polyether amine is polyether diamine having two terminal amino groups, and having a weight-averaged molecular weight of 200-4000. More preferably, the polyether diamine is poly(propylene glycol)-bis-(2-aminopropyl ether) or poly(butylene glycol)-bis-(2-aminobutyl ether).

Preferably, the polyether amine is polyether triamine having three terminal amino groups or a dentrimer amine.

Preferably, said strong acid is nitric acid, hydrogen chloride, sulfuric acid, organic acid or a mixture thereof.

Preferably, said acyl-chlorination in step 2) is carried out at 25-100° C. for a period of 48-96 hours. More preferably, said acyl-chlorination in step 2) is carried out at 60-80° C. for a period of 65-79 hours.

Preferably, said molding in step b) comprises molding the BMC material from step a) with a metallic net being embedded in the molded BMC material.

Preferably, said molding in step b) comprises disposing a metallic net in a mold and introducing the BMC material from step a) into said mold.

Preferably, said molding in step b) comprises introducing 40-60 wt % of a predetermined amount of the BMC material from step a) into a mold; disposing a metallic net in the mold and on the BMC material introduced into the mold; and introducing the remaining 60-40 wt % of BMC material from step a) into said mold so that the metallic net is sandwiched by the BMC material.

Preferably, said metallic net is made of a material selected from the group consisting of Al, Ti, Fe, Cu, Ni, Zn, Ag, Au and an alloy thereof, and the metallic net has a thickness of 0.01-3 mm, a mesh of 0.1-15 mm, and strings having a diameter of 0.01-3.0 mm.

Preferably, said carbon nanotubes are single-walled, double-walled or multi-walled carbon nanotubes, carbon nanohoms or carbon nanocapsules. More preferably, said carbon nanotubes are single-walled, double-walled or multi-walled carbon nanotubes having a diameter of 1-50 nm, a length of 1-25 μm, a specific surface area of 150-250 m²g⁻¹, and an aspect ratio of 20-2500 m²/g.

Preferably, particles of said graphite powder have a size of 10-80 mesh. More preferably, less than 10 wt % of the particles of the graphite powder are larger than 40 mesh, and the remaining particles of the graphite powder have a size of 40-80 mesh.

Preferably, a free radical initiator in an amount of 1-10% based on the weight of said vinyl ester resin is added during said compounding in step a). More preferably, said free radical initiator is selected from the group consisting of peroxide, hydroperoxide, azonitrile, redox system, persulfate, and perbenzoate. Most preferably, said free radical initiator is t-butyl peroxybenzoate.

Preferably, a mold releasing agent in an amount of 1-10%, based on the weight of said vinyl ester resin is added during said compounding in step a). More preferably, said mold releasing agent is wax or metal stearate. Most preferably, said mold releasing agent is metal stearate.

Preferably, a low shrinking agent in an amount of 5-20%, based on the weight of said vinyl ester resin is added during said compounding in step a). More preferably, said low shrinking agent is selected from the group consisting of styrene-monomer-diluted polystyrene resin, copolymer of styrene and acrylic acid, poly(vinyl acetate), copolymer of vinyl acetate and acrylic acid, copolymer of vinyl acetate and itaconic acid, and terpolymer of vinyl acetate, acrylic acid and itaconic acid. Most preferably, said low shrinking agent is styrene-monomer-diluted polystyrene resin.

Preferably, a tackifier in an amount of 1-10%, based on the weight of said vinyl ester resin is added during said compounding in step a). More preferably, said tackifier is selected from the group consisting of alkaline earth metal oxides, alkaline earth metal hydroxides, carbodiamides, aziridines, and polyisocyanates. Most preferably, said tackifier is calcium oxide or magnesium oxide.

Preferably, a solvent in an amount of 10-35%, based on the weight of said vinyl ester resin is added during said compounding in step a). More preferably, said solvent is selected from the group consisting of styrene monomer, alpha-methyl styrene monomer, chloro-styrene monomer, vinyl toluene monomer, divinyl toluene monomer, diallylphthalate monomer, and methyl methacrylate monomer. Most preferably, said solvent is styrene monomer.

The vinyl ester resins suitable for use in the present invention have been described in U.S. Pat. No. 6,248,467 which are (meth)acrylated epoxy polyesters, preferably having a glass transition temperature (Tg) of over 180° C. Suitable examples of said vinyl ester resins include, but not limited to, bisphenol-A epoxy-based methacrylate, bisphenol-A epoxy-based acrylate, tetrabromo bisphenol-A epoxy-based methacrylate, and phenol-novolac epoxy-based methacrylate, wherein phenol-novolac epoxy-based methacrylate is preferred. Said vinyl ester resins have a molecular weight of about 500˜10000, and an acid value of about 4 mg/1 hKOH-40 mg/1 hKOH.

### BRIEF DESCRIPTION OF THE DRAWINGS

FIG. 1 is FT-IR spectra of pristine Multi-Walled CNTs (abbreviated as MWCNTs), and the modified MWCNTs/POAMA of the present invention.

FIG. 2 is a plot of weight retention (%) versus heating temperature during thermogravimetric analysis (TGA) of pristine MWCNTS, acidified MWCNTs (MWCNTs-COOH), and the modified MWCNTs/POAMA of the present invention.

### DETAILED DESCRIPTION OF THE INVENTION

The present invention discloses a process for preparing a composite bipolar plate for a polymer electrolyte membrane fuel cell (PEMFC) by a bulk molding compound (BMC) process with a bulk molding compound (BMC) material comprising vinyl ester, a conductive carbon, and reactive carbon nanotubes modified by acyl chlorination-amidization reaction, and preferably, with a metallic net embedded in the BMC material. The vinyl ester/graphite composite bipolar plate and vinyl ester/graphite/metallic net composite bipolar plate prepared according to the present invention have a high electrical conductivity, high thermal conductivity and excellent mechanical properties, thanks to the acyl chlorination-amidization modified carbon nanotubes and the metallic net.

The vinyl ester resin, initiators, polyether amines, and carbon nanotubes among other materials used in the following examples and controls are described as follows:
Vinyl ester resin: phenolic-novolac epoxy-based (methacrylate) resin having the following structure, which is available as code SW930-10 from SWANCOR IND. CO., LTD, No. 9, Industry South 6 Rd, Nan Kang Industrial Park, Nan-Tou City, Taiwan:

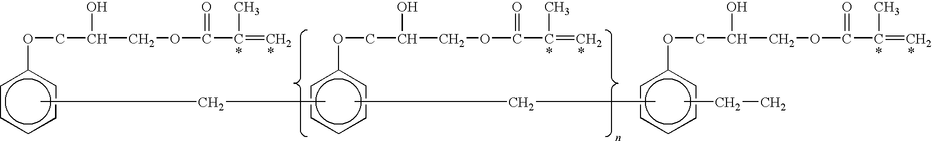

wherein n=1-3.
Initiator: t-Butyl peroxybenzoate (TBPB) having the following structure, which is available as code TBPB-98 from Taiwan Chiang-Ya Co, Ltd., 4 of 8^{th} Fl, No. 345, Chunghe Rd, Yuanhe City, Taipei Hsien:

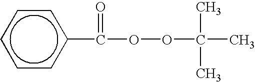

Polyether diamine: Jeffamine® D-2000 (n=33); Mw˜2000, available from Hunstsman Corp., Philadelphia, Pa., having the following structure:

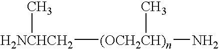

Multi-Walled CNT (abbreviated as MWCNT) produced by The CNT Company, Inchon, Korea, and sold under a code of C_{tube}100. This type of CNT was prepared by a CVD process. The CNTs had a purity of 95%, a diameter of 10-50 nm, a length of 1-25 μm, and a specific surface area of 150-250 m²g⁻¹.
Maleic anhydride (abbreviated as MA) was obtained from Showa Chemical Co., Gyoda City, Saotama, Japan.
Tetrahydrofuran, anhydrous, stabilized (THF) was supplied by Lancaster Co., Eastgare, White Lund, Morecambe, England.

The present invention will be better understood through the following examples, which are merely illustrative, not for limiting the scope of the present invention.

### PREPARATION EXAMPLE 1

### Reactive carbon nanotubes Modified by acyl chlorination-amidization Reaction

Scheme 1 depicts an overview of procedures for preparing reactive carbon nanotubes modified by acyl chlorination-amidization reaction.

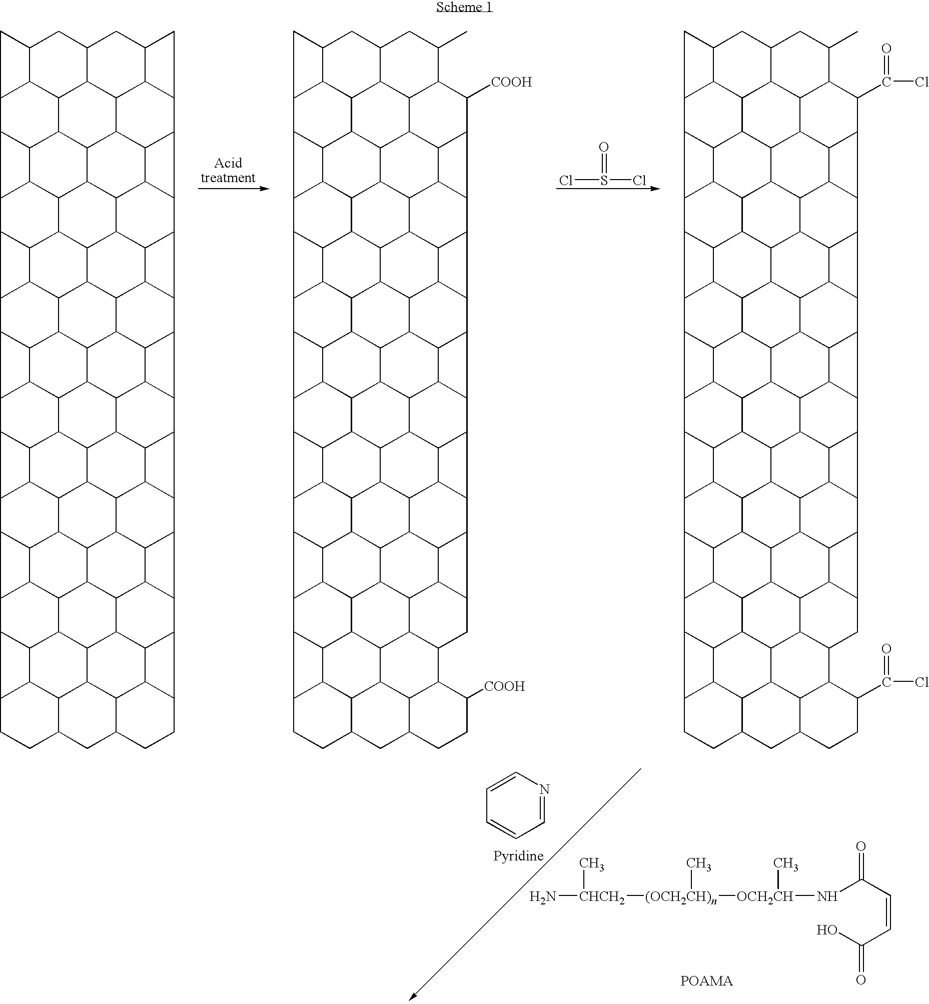

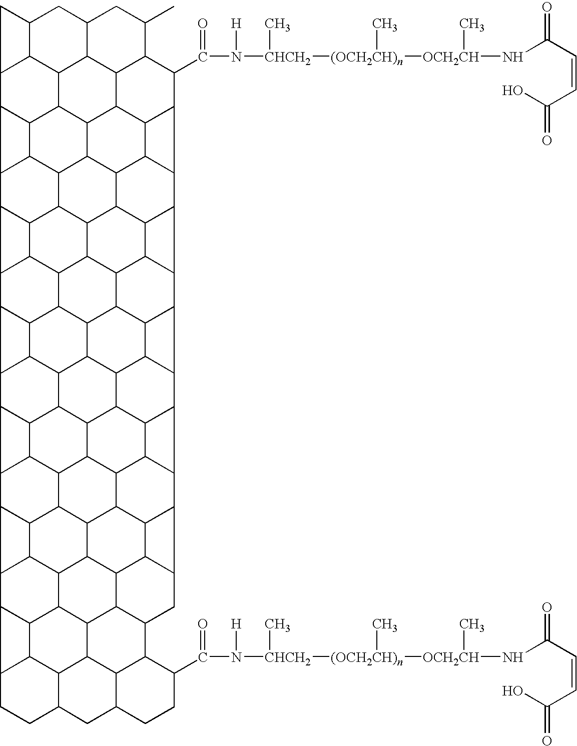

15.68 g (0.160 mole) of anhydrous maleic anhydride was slowly added to a reactor charged with 0.16 mole of poly(oxypropylene) diamine, Jeffamine® D-2000, and then stirred mechanically at 25° C. for 24 hours. The resulting product mixture was washed with deionized water several times, and dried at 100° C. to obtain maleic anhydride-polyether diamine (abbreviated as POAMA). 8 g MWCNTs and 400 mL of nitric acid were introduced into a three-neck flask, where an acidification was carried out under refluxing at 120° C. for 8 hours. The acidified MWCNTs were removed from the falsk and washed with terahydrofuran (THF), dried at 100° C., and then introduced into another three-neck flask. Nitrogen was introduced into the flask after vacuuming, 300 ml thionyl chloride (SOCl₂) was starting to introduce into flask at a reaction temperature of 70° C. to undergo an acyl-chlorination reaction for 72 hours, followed by an amidization reaction at 90° C. for 24 hours by adding a pyridine solution of POAMA. The resulting product mixture was removed from the flask and washed with deionized water several times, and dried at 100° C. to obtain a final product of reactive carbon nanotubes modified by acyl chlorination-amidization reaction (MWCNTs/POAMA).

### Identification of Modified MWCNTs

### Identification of Modified MWCNTs by FT-IR

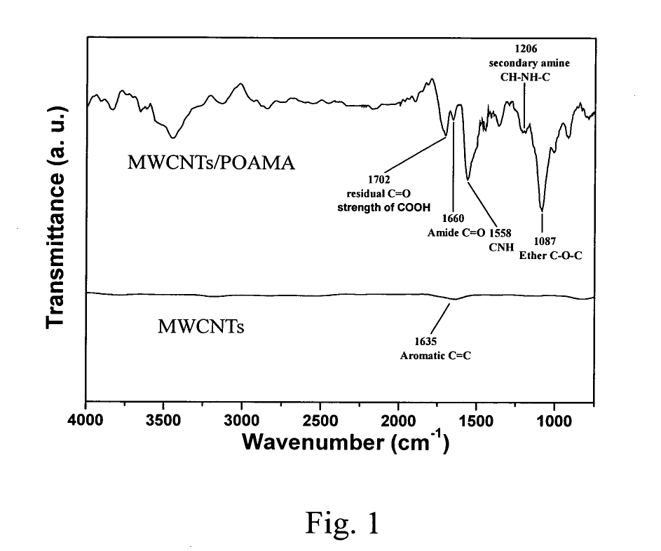

Pristine MWCNTs and the modified MWCNTs/POAMA were subjected to FT-IR analysis to identify functional groups on surfaces thereof. It can be seen from FIG. 1 that the pristine MWCNTs show only one absorption peak of the benzene structure per se of the carbon nanotubes at 1635 cm⁻¹; however, the modified MWCNTs/POAMA show an absorption peak of C—O—C segment at 1110 cm⁻¹, an absorption peak of C—NH—C bounding in POAMA at 1204 cm⁻¹, an absorption peak of N—C═O bounding at 1603 cm⁻¹, and absorption peaks of residual non-reacted COOH groups at 1706 and 1562 cm⁻¹. The FT-IR spectra in FIG. 1 confirm that POMA has been successfully grafted onto the carbon nanotubes.

Thermogravimetric analysis (TGA) of modified MWCNTs

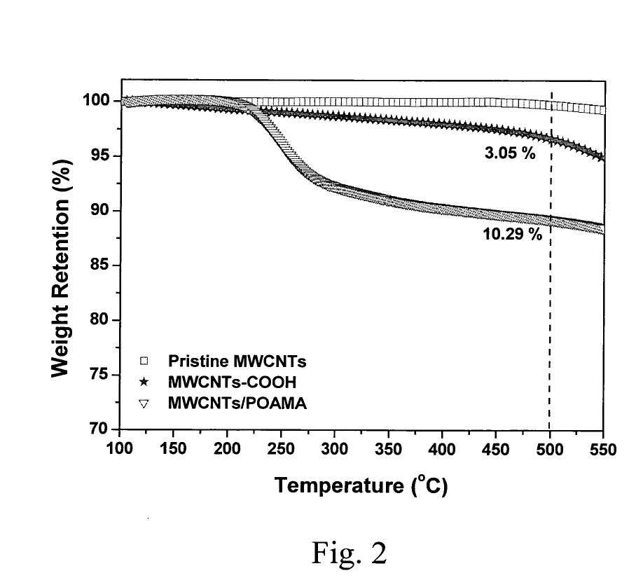

Organic molecules will decompose in advance to carbon nanotubes due to the relatively poor heat resistance of the organic molecules, when the modified MWCNTS are subjected to a heat treatment. Accordingly, the content of organic molecules in the modified MWCNTS is able to be calculated by TGA, wherein the modified MWCNTS were heated to 600° C. at a rate of 10° C./min under a nitrogen atmosphere. The residual weight of the modified MWCNTs was recorded versus the heating temperature, and the results thereof together with those of pristine MWCNTs are shown in FIG. 2. The content of organic molecules in the modified MWCNTS was determined as the weight lost at 500° C. As shown in FIG. 2, the pristine MWCNTs have only 0.6 wt % lost at 500° C., indicating that MWCNTs are thermally stable. On the contrary, MWCNTs-COOH and MWCNT/POAMA have 3.05 wt % and 10.29 wt % weight lost at 500° C., wherein the latter have a higher organic molecular content due to the molecular weight of POAMA being greater than that of nitric acid.

### CONTROL EXAMPLE 1

The graphite powder used in Control Example 1 consisted of not more than 10% of particles larger than 40 mesh (420 μm in diameter), about 40% of particles between 40 mesh and 60 mesh (420-250 μm in diameter), and about 50% of particles between 60 mesh and 80 mesh (250-177 μm in diameter).

### Preparation of BMC Material and Specimen

1. 192 g of a solution was prepared by dissolving 144 g of vinyl ester resin resin and 16 g of styrene-monomer-diluted polystyrene (as a low shrinking agent) in 32 g of styrene monomer as a solvent. 3.456 g of TBPB was added as an initiator, 3.456 g of MgO was added as a tackifier, and 6.72 g of zinc stearate was added as a mold releasing agent.
2. The solution resulting from step 1, and 448 g of graphite powder were poured into a Bulk Molding Compound (BMC) kneader to be mixed homogeneously by forward-and-backward rotations for a kneading time of about 30 minutes. The kneading operation was stopped and the mixed material was removed from the mixer to be tackified at room temperature for 36 hours.
3. Prior to thermal compression of specimens, the material was divided into several lumps of molding material with each lump weighing 65 g.
4. A slab mold was fastened to the upper and lower platforms of a hot press. The pre-heating temperature of the mold was set to 140° C. After the temperature had reached the set point, the lump was disposed at the center of the mold and pressed with a pressure of 3000 psi to form a specimen. After 300 seconds, the mold was opened automatically, and the specimen was removed.

### EXAMPLES 1-3

The steps in Control Example 1 were repeated to prepare lumps of molding material and specimens, except that 1.9 g of various MWCNTs listed in Table 1 was added together with the graphite powder to the BMC kneader in step 2. Further in Example 3, 32.5 g of the BMC material was placed into the mold, a metallic net was then disposed on the BMC material and then another 32.5 g of the BMC material was placed on the metallic net before closing the mold in the hot pressing of step 4. The metallic net had a thickness 1 mm and was made of knotted stainless steel strings (diameter of 0.43 mm) with rectangular meshes of 2.2 mm×2.4 mm.

TABLE 1

| | | Amount of pristine |
|---|---|---|
| Example | MWCNTs/dispersant | MWCNTs, g (wt %)* |
| 1 | Pristine MWCNTs | 1.98 (1%) |
| 2 | Modified MWCNTs | 1.98 (1%) |
| | (MWCNTs/POAMA) | |
| 3 | Metal net and modified MWCNTs | 1.98 (1%) |
| | (metal met - MWCNTs/POAMA) | |

*%, based on the weight of the vinyl ester resin solution prepared in Step 1.

### Electrical Properties:

### Test Method:

A four-point probe resistivity meter was used by applying a voltage and an electric current on the surface of a specimen at one end, measuring at the other end the voltage and the electric current passed through the specimen, and using the Ohm's law to obtain the volume resistivity (ρ) of the specimen according to the formula,

$$p = \frac{V}{I} * W * C F , \qquad ( formula 1 )$$

wherein V is the voltage passed through the specimen, I is the electric current passed through the specimen, a ratio thereof is the surface resistivity, W is the thickness of the specimen, and CF is the correction factor. The thermally compressed specimens from the examples and the control example were about 100 mm×100 mm with a thickness of 1.2 mm. The correction factor (CF) for the specimens was 4.5. Formula 1 was used to obtain the volume resistivity (ρ) and an inversion of the volume resistivity is the electric conductivity of a specimen.

### Results:

Table 2 shows the resistivity measured for the polymer composite bipolar plates prepared above, wherein the resin formulas are the same, and the content of graphite powder is 70 wt % with 1 wt % of different carbon nanotubes and without or with a metallic net embedded therein. The measured resistivities for the polymer composite bipolar plates prepared in Control Example 1 and Examples 1 to 3 respectively are 5.03 mΩ, 1.95 mΩ, 1.55 mΩ, and 1.55 mΩ. Table 3 shows the electric conductivity measured for the polymer composite bipolar plates prepared above. The measured conductivities for the polymer composite bipolar plates prepared in Control Example 1 and Examples 1 to 3 respectively are 199 S/cm, 513 S/cm, 643 S/cm, 644 S/cm and 1340 S/cm. The poor dispersion of MWCNTs in the polymer matrix, which typically appear as clusters in the polymer matrix, is recognized as a lack of chemical compatibility. For pristine MWCNTs, the formation of local MWCNT aggregates tend to increase the number of filler-filler hops required to traverse a given distance, thus causing decreased in-plane electrical conductivity, i.e. increased resistivity. The driving force for better in-plane conductivity of modified MWCNT polymer composite bipolar plates is better dispersion of modified MWCNTs in the polymer matrix, due to the introduction of POAMA grafted to the surface of MWCNTs. Well dispersed MWCNTs/POAMA inside the polymer matrix easily come into contact with each other and thus construct a much more efficient electrical network in the polymer composite bipolar plates. The results of MWCNTs/POAMA and metallic net—MWCNTs/POAMA in Tables 2 or 3 show no significant differences, indicating that the metallic net embedded therein does not affect the surface resistivity thereof.

TABLE 2

| | Resistivity (mΩ) |
|---|---|
| Control Ex. 1 | 5.03 |
| Example 1 | 1.95 |
| Example 2 | 1.55 |
| Example 3 | 1.55 |

TABLE 3

| | Conductivity (S/cm) |
|---|---|
| Control Ex. 1 | 199 |
| Example 1 | 513 |
| Example 2 | 643 |
| Example 3 | 644 |

### Mechanical Property: Test for Flexural Strength

### Method of Test: ASTM D790

### Results:

Table 4 shows the test results of flexural strength for polymer composite bipolar plates prepared above, wherein the resin formulas are the same, and the content of graphite powder is 70 wt % with 1 wt % of different carbon nanotubes and without or with a metallic net embedded therein. The measured flexural strength for the polymer composite bipolar plates prepared in Control Example 1 and Example 1 to 3 respectively are 28.54±0.54 MPa, 37.00±1.30 MPa, 39.16±0.46 MPa and 43.86±0.78 MPa. It is believed that the POAMA grafted to MWCNTs is reactive and compatible to the polymer matrix, and thus the modified MWCNTs/POAMA are better dispersed in comparison with the pristine MWCNTs. As a result, the addition of modified MWCNTs/POAMA will better enhance the flexural strength of the bipolar plate in comparison with the addition of pristine MWCNTs. In the case where a metallic net was further embedded in the modified MWCNTs/POAMA bipolar plate, the flexural strength thereof is increased 54% in comparison with the case where pristine MWCNTs were added, which exceeds the DOE target value (>25 MPa) by 75%.

TABLE 4

| | Flexural strength (MPa) |
|---|---|
| Control Ex. 1 | 28.54 ± 0.54 |
| Example 1 | 37.00 ± 1.30 |
| Example 2 | 39.16 ± 0.46 |
| Example 3 | 43.86 ± 0.78 |

### Mechanical Property: Test for Impact Strength

### Method of Test: ASTM D256

### Results:

Table 5 shows the test results of notched Izod impact strength for polymer composite bipolar plates prepared above, wherein the resin formulas are the same, and the content of graphite powder is 70 wt % with 1 wt % of different carbon nanotubes and without or with a metallic net embedded therein. The measured notched Izod impact strength for the polymer composite bipolar plates prepared in Control Example 1 and Examples 1 to 3 respectively are 62.38 J/m, 70.73 J/m, 118.48 J/m and 170.51 J/m. It is believed that the POAMA grafted to MWCNTs is reactive and compatible to the polymer matrix, and thus the modified MWCNTs/POAMA are better dispersed in comparison with the pristine MWCNTs. In the case where a metallic net was further embedded in the modified MWCNTs/POAMA bipolar plate, the notched Izod impact strength thereof is increased 173% in comparison with the case where pristine MWCNTs were added, which exceeds the target value of Plug Power Co. (>40.5 Jm⁻¹) by 325%.

TABLE 5

| | Impact strength (J/m) |
|---|---|
| Control Ex. 1 | 62.38 |
| Example 1 | 70.73 |
| Example 2 | 118.48 |
| Example 3 | 170.51 |

### Corrosion Property Test:

### Method of Test: ASTM G5-94

### Results:

Table 6 shows the test results of corrosion electric current test for polymer composite bipolar plates prepared above, wherein the resin formulas are the same, and the content of graphite powder is 70 wt % with 1 wt % of different carbon nanotubes and without or with a metallic net embedded therein. The measured corrosion electric current for the polymer composite bipolar plates prepared in Control Example 1 and Examples 1 to 3 respectively are 2.50×10⁻⁷ Amps/cm², 3.93×10⁻⁷ Amps/cm², 1.63×10⁻⁷ Amps/cm² and 6.67×10⁻⁸ Amps/cm². The corrosion electric currents of a level of 10⁻⁷ and 10⁻⁸ Amps/cm² of the MWCNTs/POAMA and metallic net—MWCNTs/POAMA bipolar plates as shown in Table 6 indicate that they have an excellent anti-corrosion property, 10 to 100 times superior to the metallic bipolar plates with or without anti-corrosion coating.

TABLE 6

| | Corrosion electric current (Amps/cm²) |
|---|---|
| Control Ex. 1 | 2.50 × 10⁻⁷ |
| Example 1 | 3.93 × 10⁻⁷ |
| Example 2 | 1.63 × 10⁻⁷ |
| Example 3 | 6.67 × 10⁻⁸ |

### Gas Tightness Test

### Method of Test:

Two chambers are separated by the bipolar plate prepared above, one of which is maintained at vacuum pressure, and another of which is maintained at a pressure of 5 bar. The gas tightness of the polymer composite bipolar plate is determined by observing the pressure changes in the two chambers.

### Results:

The bipolar plates in a PEMFC are gas flow fields, on which many delicate passages are formed. Hydrogen and air separately flow in the passages of two bipolar plates and diffuse through a gas diffusion membrane to MEA. The bipolar plate thus is required to have a good gas tightness to assure a high efficiency of the PEMFC.

Table 7 lists the gas tightness test results for the bipolar plates prepared above, wherein the resin formulas are the same, and the content of graphite powder is 70 wt % with 1 wt % of different carbon nanotubes and without or with a metallic net embedded therein. It can be seen from Table 7 that the polymer composite bipolar plates prepared in Control Example 1 and Examples 1 to 3 all show good gas tightness.

TABLE 7

| | Gas tightness |
|---|---|
| Control Ex. 1 | No leaking |
| Example 1 | No leaking |
| Example 2 | No leaking |
| Example 3 | No leaking |

### Test of Interfacial Contact Resistance

### Method of Test:

Ohmic resistance is caused by the obstruction to flow of electrons at various stages in their path through a gas diffusion layer (GDL), bipolar plates and contact interfaces. The interfacial contact resistance constitutes a significant part of the ohmic resistance, especially at the interfaces between the bipolar plate and the GDL. The interfacial contact resistance is inversely proportional to the pressure applied to assemble the fuel cells, a standard measuring method of which includes clamping a GDL with two bipolar plate specimens (4 cm×4 cm×3 mm) to form a sandwich structure, again clamping the sandwich structure with two gold-plated copper plates with a constant pressure (200 Ncm⁻²), measuring a resistance (R1) with a micro-ommic meter by contacting probes thereof to the two gold-plated copper plates, measuring another resistance (R2) by repeating the above procedures except that the GDL has been removed in advance, and subtracting R2 from R1 to obtain the interfacial contact resistance between the bipolar plates and the GDL.

Table 8 lists the interfacial contact resistance test results for the bipolar plates prepared above, wherein the resin formulas are the same, and the content of graphite powder is 70 wt % with 1 wt % of different carbon nanotubes and without or with a metallic net embedded therein. The interfacial contact resistance for the polymer composite bipolar plates prepared in Control Example 1 and Examples 1 to 3 respectively are 10.9 mΩcm⁻², 10.1 mΩcm⁻², 9.2 mΩcm⁻² and 10.3 mΩcm⁻². The poor dispersion of pristine MWCNTs in the polymer matrix, which typically appear as clusters in the polymer matrix, is recognized as a lack of electrical conducting path between the polymer composite bipolar plate and the GDL. On the contrary, the modified MWCNTs/POAMA have a relatively lower surface resistivity, which will increase the number of electrical conducting path between the polymer composite bipolar plate and the GDL, so that the interfacial contact resistance of Example 2 is relatively lower than that of Example 1. The interfacial contact resistance of the metallic net—MWCNTs/POAMA polymer composite bipolar plate (Example 3) is not significantly changed in comparison with other examples, indicating that the interfacial contact resistance of the polymer composite bipolar plate is not substantially affected by the metallic net embedded therein.

TABLE 8

| | Interfacial contact resistance |
|---|---|
| | (mΩcm⁻²) |
| Control Ex. 1 | 10.9 |
| Example 1 | 10.1 |
| Example 2 | 9.2 |
| Example 3 | 10.3 |

The present invention has been described in the above, and the advantages and effectiveness thereof are summarized as follows:

[1] Excellent mechanical properties and electrical properties. The polymer composite bipolar plates fabricated with modified carbon nanotubes without or with a metallic net by hot-press molding have high electrical conductivity, high thermal stability and excellent mechanical properties, and in particular excellent flexural strength, impact strength, volume conductivity, the interfacial contact resistance and gas tightness in comparison with the prior art.

[2] Flowability of the BMC material during hot-press molding is not adversely affected by the metallic net embedded therein. The mesh structure of the metallic net allows the BMC material penetrates through the metallic net during the hot-press molding, facilitating the shaping of the BMC material in the mold, so that the number of bipolar products having defects due to insufficient flowability resulting from hindrance can be reduced. The diameter of the strings of the metallic net can be chosen finer to keep the number of defected product low, when the size of the bipolar plate becomes smaller.

1. A method for preparing a fuel cell composite bipolar plate, which comprises:
a) compounding vinyl ester and graphite powder to form bulk molding compound (BMC) material, the graphite powder content ranging from 60 wt % to 95 wt % based on the total weight of the graphite powder and vinyl ester, wherein 0.05-10 wt % reactive carbon nanotubes modified by acyl chlorination-amidization reaction, based on the weight of the vinyl ester resin, are added during the compounding;
b) molding the BMC material from step a) to form a bipolar plate having a desired shaped at 80-200° C. and 500-4000 psi.

2. The method as claimed in claim 1, wherein said reactive carbon nanotubes modified by acyl chlorination-amidization reaction are prepared by a process comprising the following steps: 1) reacting carbon nanotubes with a strong acid under refluxing to form acidified carbon nanotubes; 2) reacting the acidified carbon nanotubes from step 1) with thionyl chloride (SOCl₂) to obtain acyl-chlorination carbon nanotubes having —COCl bounded to surfaces thereof; 3) conducting an amidization reaction between said acyl-chlorination carbon nanotubes and a polyamic acid resulting from a ring-opening reaction between a polyether amine and a dicarboxylic acid anhydride containing an ethylenically unsaturated group to obtain reactive carbon nanotubes modified by acyl chlorination-amidization reaction.

3. The method as claimed in claim 2, wherein said dicarboxylic acid anhydride containing an ethylenically unsaturated group is maleic anhydride.

4. The method as claimed in claim 2, wherein the polyether amine is polyether diamine having two terminal amino groups, and having a weight-averaged molecular weight of 200-4000.

5. The method as claimed in claim 4, wherein the polyether diamine is poly(propylene glycol)-bis-(2-aminopropyl ether) or poly(butylene glycol)-bis-(2-aminobutyl ether).

6. The method as claimed in claim 2, wherein the polyether amine is polyether triamine having three terminal amino groups or a dentrimer amine.

7. The method as claimed in claim 2, wherein said strong acid is nitric acid, hydrogen chloride, sulfuric acid, organic acid or a mixture thereof.

8. The method as claimed in claim 2, wherein said acyl-chlorination in step 2) is carried out at 25-100° C. for a period of 48-96 hours.

9. The method as claimed in claim 8, wherein said acyl-chlorination in step 2) is carried out at 60-80° C. for a period of 65-79 hours.

10. The method as claimed in claim 1, wherein said molding in step b) comprises molding the BMC material from step a) with a metallic net being embedded in the molded BMC material.

11. The method as claimed in claim 1, wherein said molding in step b) comprises disposing a metallic net in a mold and introducing the BMC material from step a) into said mold.

12. The method as claimed in claim 1, wherein said molding in step b) comprises introducing 40-60 wt % of a predetermined amount of the BMC material from step a) into a mold; disposing a metallic net in the mold and on the BMC material introduced into the mold; and introducing the remaining 60-40 wt % of BMC material from step a) into said mold so that the metallic net is sandwiched by the BMC material.

13. The method as claimed in claim 10, wherein said metallic net is made of a material selected from the group consisting of Al, Ti, Fe, Cu, Ni, Zn, Ag, Au and an alloy thereof, and the metallic net has a thickness of 0.01-3 mm, a mesh of 0.1-15 mm, and strings having a diameter of 0.01-3.0 mm.

14. The method as claimed in claim 1, wherein said carbon nanotubes are single-walled, double-walled or multi-walled carbon nanotubes, carbon nanohoms or carbon nanocapsules.

15. The method as claimed in claim 14, wherein said carbon nanotubes are single-walled, double-walled or multi-walled carbon nanotubes having a diameter of 1-50 nm, a length of 1-25 μm, a specific surface area of 150-250 m²g⁻¹, and an aspect ratio of 20-2500 m²/g.
